(19) United States
(12) Patent Application Publication
(10) Pub. No.: US 2015/0255203 A1
(43) Pub. Date: Sep. 10, 2015

(54) MAGNET CORE, IN PARTICULAR FOR A CURRENT TRANSFORMER, AND METHOD FOR PRODUCING SAME

(71) Applicant: VACUUMSCHMELZE GMBH & CO. KG, Hanau (DE)

(72) Inventors: Giselher Herzer, Bruchkoebel (DE); Christian Polak, Blankenbach (DE); Detlef Otte, Gruendau (DE); Gabriela Saage, Hanau (DE)

(73) Assignee: VACUUMSCHMELZE GMBH & CO. KG, Hanau (DE)

(21) Appl. No.: 14/434,894

(22) PCT Filed: Oct. 9, 2013
(86) PCT No.: PCT/EP2013/071027

§ 371 Date: Apr. 10, 2015

(30) Foreign Application Priority Data
Oct. 12, 2012 (DE) 10 2012 218 656.5

(51) Int. Cl. H01F 27/25; H01F 1/147; H01F 41/02; C21D 8/12; C21D 6/00; C22C 38/02; C22C 38/12; C22C 38/16; C22C 38/00; C22C 38/14; C22C 38/04; C22C 38/34; C22C 38/26; C22C 38/10; C22C 38/08; C22C 19/07; C22C 19/00; C22F 1/10; H01F 1/16

(52) U.S. Cl. CPC H01F 27/25; H01F 1/16; H01F 1/14766; H01F 41/022; C21D 8/1216; C21D 8/125; C21D 6/008; C22C 38/02; C22C 38/12; C22C 38/16; C22C 38/002; C22C 38/14; C22C 38/04; C22C 38/34; C22C 38/26; C22C 38/10; C22C 38/08; C22C 19/07; C22C 19/005; C21D 6/007; C21D 6/005; C21D 6/004; C21D 6/002; C21D 6/001; C22F 1/10

(57) ABSTRACT

Magnet core comprising a nanocrystalline alloy based on iron which has a permeability μ of between 1000 and 3500 and a magnetostriction of less than 1 ppm, which magnet core has a core mass of less than 4.7 g in the case of a maximum tolerance to unipolar current amplitudes of 60 A or a core mass of less than 5.3 g in the case of a maximum tolerance to unipolar current amplitudes of 100 A.

This application is a 371 national phase entry of PCT/EP2013/071027, filed 9 Oct. 2013, which claims benefit of German Patent Application No. 10 2012 218 656.5, filed 12 Oct. 2012, the entire contents of which are incorporated herein by reference for all purposes.

### BACKGROUND

1. Field

The disclosure relates to a magnet core, in particular for a current transformer, and to a method for producing such a magnet core.

2. Description of Related Art

Magnet cores for current transformers, but also for power transformers and power chokes, are typically produced as so-called toroidal tape cores which comprise strips of a soft magnetic material. For producing the soft magnetic material, various production methods and the associated production devices are known. The known production devices are generally formed as continuous annealing systems and they enable a heat treatment of rapidly solidified magnetic material (hereafter “band material”). The rapidly solidified magnet material is produced by means of a casting process and subsequently wound in the shape of a roll which is then introduced as a continuous band into the continuous annealing system and processed by the latter to a soft magnetic material. In the context of the processing, the material is subjected to a heat treatment and simultaneously put under tensile stress in order to obtain the desired magnetic properties of the band.

By way of the applied tensile stress, an anisotropy can be induced in the band material, so that the soft magnetic strip material produced therefrom has a pronounced flat hysteresis loop with a defined permeability μ (corresponding to the induced anisotropy) along the tensile stress direction, since the permeability level that can be reached with the known production method depends on the applied tensile stress.

However, the disadvantage associated with the known production method is that, owing to the production by the casting method and the subsequent winding and unwinding to a coil, and for processing in the continuous annealing oven, the amorphous band material to be processed that has been produced has a band thickness that changes locally in the longitudinal direction of the band. In combination with a constant band width resulting generally from the production, this leads to a respective local cross-sectional area that varies depending on the location in the longitudinal direction of the band. The result of this is that, due to the applied tensile force in the case of varying cross-sectional area, the locally existing tensile stress also varies in magnitude. According to the above-described relationship, this in turn also leads to changes in the locally induced anisotropy and thus in the local permeability with the varying cross-sectional area.

However, not only the described change in cross-sectional area, but other parameters as well, such as the heat treatment temperature, an optionally provided magnetic field, the throughput speed of the band, the oven length, the heat conduction and the heat transfer to the band, the band thickness as well as the alloy used, have an influence on the induced anisotropy Kᵤ in such a process. Since these parameters in the prior art can never be kept constant, the locally induced anisotropy and thus the local permeability also change accordingly.

In addition, magnet cores, in particular toroidal tape cores, especially if they are to be used for current transformers, should be as small, light-weight, and inexpensive as possible. These properties depend essentially on the selection of the band material but also on the production method used, by means of which the magnetic properties of the material can be influenced.

Nanocrystalline alloys based on iron have particularly good soft magnetic properties. Flat hysteresis loops, which are characterized by a low remanence ratio and a linear magnetization behavior in the central portion of the hysteresis loop, play a particularly important role for the application. Such flat loops can be adjusted by heat treatment in the magnetic field. Here, the resulting relatively high permeabilities are typically above μ=10,000. Although desirable for many applications, such high permeability values are less suitable for certain applications such as, for example, current transformer cores for applications in current transformers with DC compatibility. For the application in these current transformer cores, on the other hand, lower permeability values in a range from μ=500 to 10,000 are required, for example, μ=1000 to 5000. This can be achieved, for example, with amorphous Co based alloys such as VITROVAC 6150 which, at a saturation magnetization of 1.0 T, have permeability values in the range from μ=600 to 3000, depending on the exact composition and heat treatment. However, since Co is a very expensive raw material, nanocrystalline Fe-based alloys with additions of Ni, and if need be, lower additions of Co have been described, by means of which it is also possible, in contrast to purely iron-based alloys, to adjust low permeability values in the range μ=1000 to 10,000 (depending on the concentration of Ni and Co) after heat treatment in the magnetic field. However, the disadvantage here is that, as a result of the Ni and Co addition, the magnetostriction increases, in comparison to purely iron-based compositions, to values of several ppm. This makes the magnet core sensitive to mechanical stresses. However, it is also known that permeabilities of less than 10,000 can also be adjusted by means of a heat treatment of nanocrystalline Fe alloys under tensile stress, in contrast to the magnetic field treatment. However, there is still a need to produce magnet cores that have the smallest possible volume and the smallest possible mass and that can be produced cost effectively.

### SUMMARY

A problem addressed by embodiments of the invention is to eliminate the disadvantages according to the prior art. In particular, a magnet core is to be specified which is particularly suitable for current transformers and which has a low mass in comparison to the prior art. In addition, to the extent possible, said core should have a comparatively low volume, and it should be possible to prepare it cost effectively. Furthermore, a method for producing such a magnet core as well as applications of the magnet core are to be specified.

This problem is solved by the features of embodiments of the invention as described herein.

In an embodiment, the problem is solved by a magnet core, for example, for use in a current transformer, with a soft magnetic strip material consisting of a nanocrystalline alloy based on iron, which has a permeability μ of between 1000 and 3500 and a magnetostriction of less than 1 ppm. The magnet core can be obtained by a method comprising the provision of a band-shaped material; the heat treatment of the band-shaped material at a heat treatment temperature; the application to the heat-treated band-shaped material of a tensile force in the longitudinal direction of the band-shaped material, in order to generate a tensile stress in the band-shaped material, so as to obtain the soft magnetic strip material, wherein, for the production of the soft magnetic strip material from the band-shaped material, the following are also provided for: the determination of at least one measured magnetic variable of the soft magnetic strip material produced, and the control of the tensile force for adjusting the tensile stress in reaction to the measured magnetic variable determined.

The nanocrystalline alloy based on iron for the soft magnetic strip material contains, for example, at least 50 atomic % of iron, at most 4 atomic % of niobium and at least 15 and at most 20 atomic % of silicon. It is particularly preferable for the nanocrystalline alloy based on iron to contain at most 2 atomic % of niobium. A silicon content of at least 15 atomic % is advantageous, so as to obtain a magnetostriction that is less than 1 ppm. A niobium content of at most 4 atomic % is advantageous, so as to keep the costs of the magnet core according to the invention as low as possible. Therefore, a niobium content of at most 2 atomic % is particularly advantageous.

In an embodiment of the invention, the nanocrystalline alloy based on iron is an alloy (hereafter referred to as alloy A) which
consists of Fe_{100-a-b-c-d-x-y-z}CuₐNb_{b}M_{c}T_{d}SiₓB_{y}Z_{z} and up to 1 atomic % of contaminants, wherein M is one or more of the elements Mo, Ta or Zr, T is one or more of the elements V, Mn, Cr, Co or Ni and Z is one or more of the elements C, P or Ge, and wherein:
0 atomic %≦a<1.5 atomic %,
0 atomic %≦b<2 atomic %,
0 atomic %≦c<2 atomic %,
0 atomic %≦d<5 atomic %,
14 atomic %<x<18 atomic %,
5 atomic %<y<11 atomic % and
0 atomic %<z<2 atomic %,
the alloy has a nanocrystalline structure in which at least 50 volume % of the grains have a mean size smaller than 100 nm,
the alloy has a magnetic hysteresis loop with a central linear portion,
the alloy has a remanence ratio, Jᵣ/Jₛ, <0.1, and
the alloy has a ratio of coercitivity field strength, H_{c}, to anisotropy field strength, Hₐ, <10%.

A nanocrystalline alloy based on iron which contains at least 50 atomic % of iron, at least 2 and at most 4 atomic % of niobium and at least 15 and at most 20 atomic % of silicon is referred to as “alloy B” below.

For the preparation of the magnet core, a band-shaped material is first produced. The band-shaped material can be an alloy which comprises the same constituents as the nanocrystalline alloy based on iron in the same proportions, but which is an amorphous material. In addition, the band-shaped material differs in its magnetic properties from the nanocrystalline alloys based on iron provided according to an embodiment of the invention. The magnetic properties are adjusted by process steps, that is to say the heat treatment with action of a tensile force, as a result of which the soft magnetic strip material is obtained.

The shape in the form of a band allows not only the production of the nanocrystalline alloy based on iron under tensile stress in a continuous oven, but also the preparation of a magnet core with any number of layers desired. The band-shaped material is obtained preferably by a casting method.

The permeability of the nanocrystalline alloy based on iron, which according to an embodiment of the invention should be between 1000 and 3500, can be determined, in particular, by selection of the tensile stress in the heat treatment. The tensile stress can here be up to approximately 800 MPa without the band tearing. Thus, a band with a permeability within the overall permeability range of μ=1000 to μ=3500 is achievable.

The lower the permeability is, the higher the unipolar components (=direct current components) of the electrical currents through the turns of the magnet core can be without the material becoming saturated. Similarly, in the case of equal permeability, the higher the saturation polarization, J_{S}, of the material is, the higher these currents can be. On the other hand, the inductivity of the magnet core increases with the permeability and the construction size. In order to build magnet cores with simultaneously high inductivity and high compatibility with respect to direct current components, it is therefore advantageous to use alloys with increased saturation polarization.

The permeability of the nanocrystalline alloy based on iron is preferably between 1000 and 3000. The tensile stress used in the heat treatment is preferably between 10 and 50 MPa.

In an embodiment of the invention, at a maximum direct current load of 60 A, the magnet core has a core mass of less than 4.7 g. In another embodiment of the invention, at a maximum direct current load of 100 A, the magnet core has a core mass of less than 5.3 g.

In an embodiment of the invention, the nanocrystalline alloy based on iron has a saturation magnetization of more than 1.3 T. By increasing the saturation magnetization, the size of the magnet core can be reduced further, and its mass can be decreased. This is possible since, owing to the higher saturation, the permeability can be increased without the core becoming prematurely saturated. In addition to the mass reduction, the magnet cores according to the invention can be produced more cost effectively due to the lower Nb content.

The inventors observed that nanocrystalline alloys based on iron with a magnetostriction of less than 1 ppm have particularly good soft magnetic properties even in the case of internal stress, if the permeability μ is between 1000 and 3500.

The nanocrystalline alloy based on iron is obtained in the form of a soft magnetic strip material made of an amorphous band-shaped material. The material is thus produced as a band, before it is subjected to the heat treatment with the action of a tensile force to obtain the strip material. The strip material can have a thickness from 10 μm to 50 μm. This thickness enables the winding of the magnet core according to an embodiment of the invention with a high number of layers while having a small outer diameter.

According to an embodiment, the soft magnetic strip material can be coated with an insulating layer, in order to electrically insulate the layers of the magnet core from one another. The layer can be, for example, a polymer layer, a powder paint or a ceramic layer.

### Alloy A

Alloy A has a composition with a niobium content of less than 2 atomic percent (atomic %). This has the advantage that the raw material costs are lower in comparison to a composition with a higher niobium content, since niobium is a relatively expensive element. Moreover, the lower limit of the silicon content and the upper limit of the boron content are established so that the alloy can be produced in the form of a band under a tensile stress in a continuous oven, wherein the above-mentioned magnetic properties are achieved. Accordingly, with this production method, alloy A can also have the desired soft magnetic properties for magnet core applications, in spite of the low niobium content.

Due to the nanocrystalline structure with a grain size of less than 100 nm in at least 50 volume percent of alloy A, a low saturation magnetostriction is achieved at high saturation polarization. The heat treatment under tensile stress results in a magnetic hysteresis loop with a central linear portion, a remanence ratio of less than 0.1, and a coercitivity field strength of less than 10% of the anisotropy field. Associated therewith are low remagnetization losses and a permeability which, in the linear central portion of the hysteresis loop, is independent of the applied magnetic field or of the premagnetization.

Here, the central portion of the hysteresis loop is defined as the portion of the hysteresis loop which lies between the anisotropy field strength points which characterize the transition to saturation. A linear portion of this central portion of the hysteresis loop is defined herein by a nonlinearity factor NL of less than 3%, wherein the nonlinearity factor is calculated as follows:

NL (in %)=100(δJᵤₚ+δd_{down})/(2Js) (1)

Here, δJᵤₚ and δJ_{down} denote the standard deviation of the magnetization from a line of best fit through the ascending and descending branch of the hysteresis loop between magnetization values of ±75% of the saturation polarization Jₛ.

Alloy A is thus particularly suitable for a magnet core which has a reduced size and a smaller mass with lower raw material costs and simultaneously the desired soft magnetic properties for the application as magnet core. In an embodiment example, the remanence ratio of alloy A is less than 0.05. The hysteresis loop of alloy A is thus even more linear or flatter. In an additional embodiment example, the ratio of coercitivity field strength to anisotropy field strength is less than 5%. In this embodiment example as well, the hysteresis loop is even more linear, so that the remagnetization losses are even lower. Especially linear loops here result in the lower permeability range, i.e., in approximately μ=1000 to 3000.

In an additional embodiment example, at least 70 volume percent (volume %) of the grains have a mean size of less than 50 nm. This allows a further increase in the magnetic properties. Alloy A in the form of a band under tensile stress is subjected to a heat treatment in order to generate the desired magnetic properties. Alloy A, i.e., the finished heat treated band is thus also characterized by a structure which has resulted from its production method. In an embodiment example, the crystallites have a mean size of approximately 20 to 25 nm and a remanent elongation in the longitudinal band direction between approximately 0.02% and 0.5%, which is proportional to the tensile stress applied during the heat treatment. The crystalline grains can have an elongation of at least 0.02% in a preferential direction.

### Alloy B

Alloy B differs from alloy A first in that its niobium content is at least 2 atomic % and at most 4 atomic %. For the rest, alloy B corresponds to alloy A.

### Production Method

A method for producing the magnet core according to an embodiment of the invention comprises the steps of:
provision of a band-shaped material;
heat treatment of the band-shaped material at a heat treatment temperature;
application to the heat-treated band-shaped material of a tensile force in the longitudinal direction of the band-shaped material, in order to generate a tensile stress in the band-shaped material to obtain the soft magnetic strip material, wherein, for the production of the soft magnetic strip material from the band-shaped material, the following are also provided for:
determination of at least one measured magnetic variable of the soft magnetic strip material produced, and
control of the tensile force for adjusting the tensile stress in reaction to the determined measured magnetic variable.

The sequence of the steps can also vary depending on the application case.

Thus, a starting band-shaped material, in particular an amorphous band-shaped material, is provided, which is subjected, in a subsequent step, to a heat treatment by exposure to the heat treatment temperature. Subsequently, the band-shaped material is exposed to the described tensile force simultaneously with the heat treatment and/or thereafter, in order to generate a tensile stress in the band-shaped material. By means of the applied tensile stress, a structural change in the material and thus an anisotropy, for example, a transverse anisotropy, can be induced in the band-shaped material. For example, the tensile stress is adjusted in such a manner that the soft magnetic strip material produced by the method has a pronounced flat hysteresis loop with a defined permeability μ in the tensile stress direction. The application of the tensile force can occur simultaneously with the heat treatment.

As already described above, the anisotropy introduced here is proportional to the tensile stress introduced, wherein the permeability depends on the anisotropy. A graphic representation and a detailed description of the relationships are indicated in FIGS. 3a and 3b and the associated description.

A soft-magnetic strip material with defined magnetic properties and an altered structure is produced from the band-shaped material by means of the described steps and is subsequently subjected to a measurement for determining one or more measured magnetic variables.

The latter allow conclusions regarding the magnetic properties of the strip material produced, for example, for a magnetic characterization of the soft magnetic strip material produced. As an example, a list of measured magnetic variables that can be determined is indicated further below.

Knowing the at least one measured magnetic variable, the described control of the tensile force can occur, in order to thus adjust the tensile stress to a desired value. Thus, by means of the tensile force, the tensile stress is varied, wherein the control of the tensile force occurs as a function of the at least one measured magnetic variable determined.

According to an embodiment, in the step of regulating the tensile force, the tensile force is varied in such a manner that the tensile stress in the longitudinal direction of the band-shaped material is kept substantially constant at least in some sections along the longitudinal direction. Accordingly, the tensile force is varied in such a manner that the tensile stress existing locally in the band-shaped material can be kept constant. In this manner, an influence on the local tensile stress by the local cross-sectional area which varies as a result of the production over the longitudinal extension of the band-shaped material can be compensated so that a variation in the associated tensile stress connected therewith can be substantially prevented, as would be the case if only a constant tensile force were applied.

Accordingly, in the continuously moving band-shaped material, in the case of constant tensile stress, a corresponding anisotropy K_{U} can be induced, which results in a permeability μ that is also constant. In addition, other parameters are also known that can influence and change an induced anisotropy in such a production method; they include, for example, the heat treatment temperature, the throughput speed of the band-shaped material, the path distance for the exposure to the heat treatment temperature (that is to say an oven length), the (mean) thickness of the band-shaped material, the heat conduction or the heat transfer to the band-shaped material and/or the type of alloy selected as well as parameters of the magnetic field that can optionally be provided.

Since, in practice, these parameters can never be kept constant, the control of the tensile stress, that is to say of a force that in the process can be adjusted variably in the band, can be used to keep the induced anisotropy Kᵤ and thus the permeability μ constant over the band length. For this purpose, the force in the band is varied, for example, in small steps around a target tensile stress value, in order to compensate for local influences, such as temperature differences, band thickness fluctuations, slight deviations in the throughput speed, variations in the material composition, etc.

For example, it is thus possible to keep the induced anisotropy case K_{U} and thus the permeability constant over a defined section or even over the entire length of the band-shaped material by regulating the tensile force as a function of the measured magnetic variable determined, for the purpose of adjusting a desired tensile stress.

If the tensile stress is kept constant only in some sections or if it is varied continuously by means of the described control, then this allows the additional possibility of keeping the tensile stress constant at a first value in a first section and at a second value in a subsequent second section by changing a corresponding specified value. Naturally, it is also possible to provide more than two sections each with an individually set constant tensile stress value. Subsequently, for example, each section can be used for winding a separate magnet core, and thus magnet cores with different magnetic properties can be produced successively.

For example, the control of the tensile force comprises an automatic adjusting of the tensile stress around a predefined target tensile stress value. The tensile force introduced into the band-shaped material can thus be varied automatically in small steps or continuously around the target tensile stress value, in reaction to the at least one measured magnetic variable, in order to compensate for local influences in the band-shaped material, such as, for example, temperature differences, band thickness fluctuations, deviations in the throughput speed and/or variations in the material composition.

For example, the tensile force is regulated continuously, i.e., a continuous verification and (re)adjustment occur. As described above, a predefined target value can likewise be provided for only a defined section of the band-shaped material, so that in each case individual tensile stress levels can be assigned to one or more successive sections, as a result of which, over the length of the respective section, the induced anisotropy or the permeability achieved thereby can be adjusted in a controlled manner in a broad range.

For example, in this manner, as a function of a selected material composition of the band-shaped material or of an alloy used for this purpose, a permeability μ ranging from less than 1000 to 3500 can be reached. Such a relatively low permeability μ is advantageous for current transformers.

The described embodiments thus offer the advantage that a combination of the two aspects above is made possible, namely that the tensile stress can be kept constant over wide ranges and that a tensile stress level is specified section by section by a respective target tensile stress value. For example, it is not sufficient to introduce only a high tensile strength into the band-shaped material in order to achieve the desired permeability, since the desired target permeability would thus be adjusted exactly for only a particular local area of the band-shaped material. Rather, in addition to the defined tensile force level, it must be possible to perform very fine and above all interference-free tensile force variations, in order to be able to keep the tensile stress, as described, at a constant value.

In other words, using the described method, a soft magnetic strip material can be produced which has one or more different, in each case constant, permeability levels or which has a continuously changing permeability, wherein each level can be produced by means of the control according to an embodiment of the invention with very slight deviations from the predetermined target permeability value over the entire strip length or over one or more defined sections.

Furthermore, the method can comprise, as an optional step, the exposure of the band-shaped material to a magnetic field (magnetic field treatment), wherein the magnetic field treatment can occur, for example, subsequent to or simultaneously with the heat treatment. Naturally, it is also possible to provide a treatment with more than one magnetic field, such as, for example, several magnetic fields each having a different spatial alignment.

In addition, the method can comprise at least one step of winding at least one defined section of the soft magnetic strip material produced in order to produce at least one magnet core in the form of a toroidal tape core, after the step of determining the at least one measured magnetic variable. As a result of the winding step, the magnet core according to the invention is obtained in the form of a toroidal tape core.

The strip material produced can thus be wound subsequent to the end of the above-described steps to form one or more toroidal tape cores. Since it is possible to produce the most constant or steady permeability curve possible by means of the method on one or more levels, magnet cores can be produced therefrom each having a very constant permeability distribution within the magnet core, but also low sample variation of several magnet cores with the same target value for the permeability.

When using the method according to an embodiment of the invention, the magnet cores of the invention can be produced with very low sample variation of less than ±2.5%. The magnet cores according to the invention can therefore be dimensioned accurately, which results in the obtention of a clear mass reduction of up to 50%, in comparison to the prior art. The cores produced according to the prior art have a clearly higher sample variation of up to ±20%. This high tolerance must be maintained at the time of the dimensioning, which results in greater sizes and higher core masses.

According to an additional embodiment, the winding step is controlled in reaction to the at least one measured magnetic variable. This allows, for example, a controlled winding of defined sections which are determined via a characterization by means of the measured magnetic variables determined. Thus, for example, if a different permeability level is reached, that is to say a jump in the permeability curve is recognized or generated, then the winding can be controlled accordingly. For example, the winding of a first magnet core can be terminated and a winding of a new magnet core can be started.

According to another embodiment, the winding step comprises winding a defined number of band layers of the soft magnetic strip material produced, in order to produce the at least one toroidal tape core, wherein defining of the number of band layers occurs in reaction to the at least one measured magnetic variable. For this purpose, for example, the local band thickness and the associated magnetic cross-sectional area are taken into consideration for the winding step. It is possible, already prior to the actual winding, to determine a number of band layers and, in the context of the winding, to vary said number of windings so that the wound core has a predefined core cross-sectional area A_{KFe}.

The described method consequently offers the possibility of producing a number of cores, wherein each core also has, in addition to a defined permeability curve over the length of the wound strip material, a defined core cross section with one core cross-sectional area.

Thus, the band shape allows not only a processing of the alloy under tensile stress in a continuous annealing installation described in further detail below, but also the production of toroidal tape cores with any number of layers. In this manner, the size and the magnetic properties of a toroidal tape core can be adapted simply by an appropriate selection of the number of turns or band layers to a provided application.

For example, the number of the band layers can be varied here so that a cross-sectional area A_{KFe1} of a first toroidal tape core and a cross-sectional area A_{KFe2} of a second toroidal tape core are substantially of equal size. Thus, any number of toroidal tape cores can be produced, each having a core cross-sectional area of equal size or at the very least having a very small deviation of the respective core cross-sectional area. The number of band layers can also be varied, for example, in such a manner that, alternatively or additionally, the permeability of the first toroidal tape core and the permeability of the second toroidal tape core are of substantially equal size.

Thus, the effect of the permeability which is constant at least in sections and the effect of a core cross-sectional area of equal size can also be promoted by an averaging process during the winding of the respective core. By means of this overlapping during the winding, the respective positive and negative deviations from a predefined target value are compensated over a defined length (for example, several meters) of the strip material. Thus, a completely verified core can be produced from the starting material, with very little sample variation with regard to the permeability and the core cross-sectional area, in a single continuous manufacturing procedure or process by way of heat treatment until production of a magnetic core. In this manner, narrower core tolerances are made possible, so that smaller magnet cores can be produced, which in turn contribute to savings in terms of material and cost.

The special significance of the measured magnetic variables measured in the soft magnetic strip material produced, for the magnet cores wound subsequently therefrom and the respective low sample variation achieved thereby, is explained in further detail below.

Usually, the heat treatment temperature and a throughput speed of the band-shaped material are selected as a function of the respective selected alloy in such a manner that a magnetostriction in a nanocrystalline state of the corresponding heat-treated soft magnetic strip material is under 1 ppm. This should be considered a basic condition in order to wind a magnet core from the heat-treated soft magnetic strip material, which has a similar or even identical permeability compared to the unwound strip material, even after the winding process in its wound state. The reason for this is that a product from bending stresses caused by the winding and the value of the magnetostriction represents an additional anisotropy induced in the strip material and must therefore be kept as low as possible. If this cannot be achieved, the permeability of the wound core would otherwise differ more or less strongly from that of the strip material.

In addition, it can be observed that the highest possible anisotropy induced in the preparation process of the soft magnetic strip material has the effect that the core is increasingly sensitive to the ever constant small additional anisotropies due to the winding stresses. A corresponding comparison of a hysteresis measured on the unwound soft magnetic strip material and a hysteresis determined on a wound toroidal tape core is represented in FIG. 4.

As already mentioned, the band-shaped material used as starting material in the context of the described method can be subjected to a heat treatment under tensile stress, in order to generate the desired magnetic properties. Here, the selected temperature is of great importance, since the structure of the material is influenced as a function of said temperature. Said temperature can be selected so that the heat treatment temperature is above a crystallization temperature of the band-shaped material, in order to convert the band-shaped material from an amorphous state to a nanocrystalline state. The nanocrystalline state is advantageous for the toroidal tape cores and responsible for the excellent soft magnetic properties of the strip material produced. In this manner, a low saturation magnetostriction and simultaneously a high saturation polarization are reached due to the nanocrystalline structure. In the case of an appropriate alloy selection, the proposed heat treatment under a defined tensile stress results in a magnetic hysteresis with a central linear portion. Associated with this are low resetting losses and a permeability which, in the linear central portion of the hysteresis, is largely independent of the applied magnetic field or of the premagnetization, features which are particularly desirable in magnet cores for current transformers.

According to an embodiment of the method according to the invention, the determination of the at least one measured magnetic variable occurs in real time. In this case, it is possible to carry out a magnetic characterization “in line” within a production line in running operation. As an example, a selection of measured magnetic variables is also described below.

In this manner it is possible that the band-shaped material or the soft magnetic strip material produced can run through a production device at full speed, without requiring an interruption or deceleration of the process for the determination.

For example, the at least one measured magnetic variable can be selected from a group consisting of the magnetic saturation flux, the magnetic band cross-sectional area A_{Fe}, the anisotropy field strength, the permeability, the coercitivity field strength and the remanence ratio of the soft magnetic strip material produced. All these measured variables and the associated magnetic properties of the strip material produced have in common that they are dependent on the tensile stress introduced into the material and can thus be regulated accordingly by means of the described method.

If the step of determining the measured magnetic variable also includes determining the local magnetic cross-sectional area A_{Fe}, then this makes it possible not only to produce a soft magnetic strip material which, as described, has the most constant possible permeability curve along its length, but it also simultaneously allows the obtention of information on the thickness course of the strip material produced. This combination makes it possible to wind, from the produced strip material, toroidal tape cores with permeability values that can be adjusted very precisely and at the same time with adjustable core cross-sectional areas A_{KFe} of the toroidal tape core, since a required strip length can be defined already before the actual winding.

For the implementation of the method according to an embodiment of the invention, a device can be provided for producing soft magnetic strip materials, with
an inlet-side material feed for providing band-shaped material,
a heat treatment device for the heat treatment of the band-shaped material at a heat treatment temperature,
a tensioning device for applying to the heat treated band-shaped material a tensile force for generating a tensile stress in a longitudinal band axis of the band-shaped material, at least in the area of the heat treatment device, wherein
the tensioning device is designed so that it can be regulated for varying the tensile force in the band-shaped material, in order to adjust the tensile stress,
wherein, for generating the soft magnetic strip material, the device additionally comprises a measurement arrangement for determining at least one measured magnetic variable of the soft magnetic strip material produced, and
wherein a control unit for regulating the tensioning device is provided, which is designed in such a manner, and connected to the measurement arrangement in such a manner, that the control of the tensioning device includes regulating the tensile force in reaction to the at least one measured magnetic variable determined.

The device can, in addition, comprise a winding unit with at least one winding spindle for winding a defined section of the soft magnetic strip material produced, so as to produce at least one toroidal tape core, wherein the winding unit is designed in such a manner, and connected to the measurement arrangement in such a manner, that the winding occurs in reaction to the at least one measured variable determined.

Furthermore, the device can comprise a device for generating at least one magnetic field for applying the at least one magnetic field generated to the heat treated material. The magnetic field can be aligned transversely and/or perpendicularly to the longitudinal band axis or band surface.

For example, the tensioning device for generating the tensile force in the band-shaped material can be designed so that the band-shaped material can nevertheless advance continuously and the tensile force can be varied in accordance with the specification of the control unit based on the magnetic measurement magnitude determined by the measurement arrangement. For example, the tensioning device must be able to introduce a sufficiently high tensile force into the band-shaped material and ensure a required precision in order to allow, for example, reproducible changes in tensile force, and in order to be able to apply and ensure the predetermined tensile force even in the case of a plastic elongation of the band-shaped material.

For this purpose, the tensioning device for generating the tensile force comprises two S-shaped roll drives connected to one another, a dancer roll control and/or a vibration control as well as torque-controlled braking drives and/or mechanically braked rolls. However, it is also possible to use other suitable tensioning devices that satisfy the mentioned requirements.

Advantageously, the band-shaped material supplied via the inlet-side material feed comprises a material that has been cut to a final width and/or a band-shaped cast material and/or a material wound to form a coil. By means of such a prefabrication, a simple processing in a heat treatment device is made possible, for example, in a continuous annealing installation.

For example, the measurement arrangement is arranged in a section downstream of the heat treatment device and/or the tensioning device, so that the soft magnetic strip material produced, which runs through the measurement arrangement, is free of the tensile force produced by the tensioning device. For transporting and winding the strip material, it is obvious that a certain tension or tensile force must nevertheless be applied.

By means of the method according to an embodiment of the invention, the magnet core according to the invention can be obtained. According to an embodiment, the soft magnetic strip material can be coated with an insulation layer, in order to electrically insulate the layers of the toroidal tape core from one another. In the process, the strip material can be coated with the insulation layer before and/or after the winding to form the magnet core.

Obviously, the above-mentioned features, yet to be explained below, can be used not only in the combination indicated here, but also in any other suitable combinations or individually alone.

In accordance with the provisions of embodiments of the invention, the use of the magnet core according to the invention for a current transformer is also provided for. Using the magnet core according to the invention, it is possible advantageously to obtain, in particular, a direct current-compatible current transformer. The requirements placed on such a current transformer are described in WO 2004/088681 A2 as well as in standards such as IEC 62053-21 and IEC 62053-23. The current transformers with magnet cores according to the invention are in compliance with these requirements.

The invention is thus based on the finding that magnet cores for current transformers can be obtained, which have a low mass and a small volume and can be produced cost effectively, if (i) a nanocrystalline alloy based on iron with a magnetostriction of less than 1 ppm is used, whose permeability, which is between μ=1000 and 3500, is adjusted in a targeted manner by heat treatment of the alloy under tensile stress, and (ii), in particular, by means of the described inline control during the heat treatment, the dispersion range of the magnetic values of the core width is reduced. The reduced dispersion allows an accurate optimization of the core dimensions, resulting in a clear reduction of the core mass. The core mass, finally, (iii), can be further reduced by increasing the saturation magnetization to more than 1.3 T, which is achieved by a lowering of the Nb content below 2 atomic %.

### BRIEF DESCRIPTION OF DRAWINGS

The invention is explained in further detail below based on embodiment examples that are not intended to limit the invention, in reference to the drawings.

FIG. 1 shows a diagrammatic representation of the course of the procedure according to a first embodiment,

FIG. 2 shows an example of an embodiment of a device for carrying out the method, in a diagrammatic representation,

FIGS. 3a and 3b show the foundations of the tensile stress-induced anisotropy, a definition of the mechanical and magnetic terms, and, in two diagrams, the relationship between a tensile stress introduced into a band-shaped material and a resulting anisotropy or permeability,

FIG. 4 shows, in a diagram, the comparison of a hysteresis measured on an unwound soft magnetic strip material with a hysteresis determined on the wound core, and

FIG. 5 shows an embodiment of a magnet core in a diagrammatic perspective cross-sectional representation.

### DETAILED DESCRIPTION OF SPECIFIC EMBODIMENTS

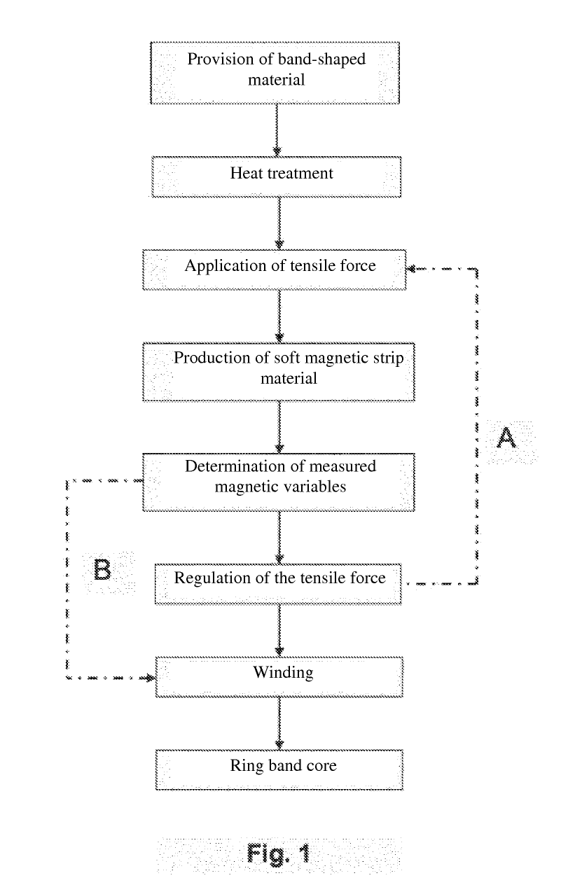

In FIG. 1, an example of the course of the procedure for producing a soft magnetic strip material for magnet cores in the form of toroidal tape cores according to a first embodiment is represented. The method includes the provision of a band-shaped material, the heat treatment of the band-shaped material at a heat treatment temperature, and the application of a tensile force in the longitudinal direction of the band-shaped material to the heat treated band-shaped material, in order to generate a tensile stress in the band-shaped material. These steps are used for producing the soft material strip material from the band-shaped material. In addition, the method includes determining at least one measured magnetic variable of the soft magnetic strip material produced, and regulating the tensile force for adjusting the tensile stress in reaction to the measured magnetic variable (arrow A) determined. Optionally, the method comprises a step of winding at least one defined section of the soft magnetic strip material produced in order to produce at least one toroidal tape core after the step of determining the at least one measured magnetic variable. For example, the winding step is controlled or regulated in reaction to the at least one measured magnetic variable (arrow B).

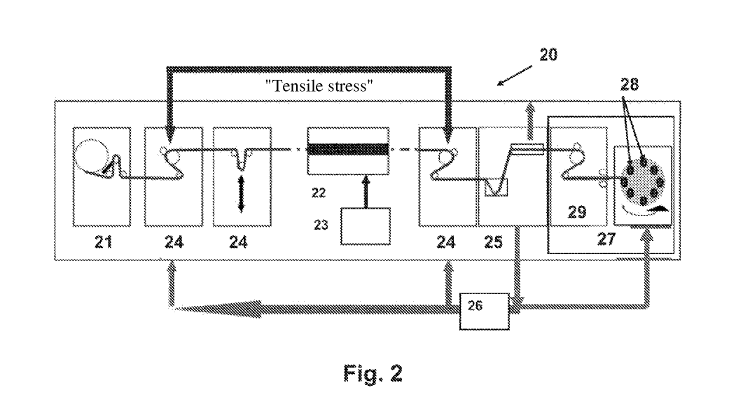

FIG. 2 shows a diagrammatic representation of a device 20 for producing a soft magnetic strip material according to an embodiment. The device 20 comprises an inlet-side material feed 21 for providing band-shaped material, a heat treatment device 22 for the heat treatment of the band-shaped material at a heat treatment temperature, a tensioning device 24 for applying a tensile force to the band-shaped material in order to generate a tensile stress in a longitudinal band axis of the band-shaped material at least in the area of the heat treatment device 22. The tensioning device 24 is designed so that it can be controlled so as to vary the tensile stress in the band-shaped material, in order to adjust the desired tensile stress for producing the soft magnetic strip material.

The device 20 comprises, in addition, a measurement arrangement 25 for determining at least one measured magnetic variable of the soft magnetic strip material produced, and a control unit 26 for regulating the tensioning device 24, wherein the control unit 26 is designed in such a manner, and connected to the measurement arrangement 25 in such a manner, that the control of the tensioning device 24 includes controlling the tensile force in reaction to the at least one magnetic measurement size that has been determined. In the represented embodiment, the tensioning device 24 comprises two mutually coupled S-shaped roll drives as well as a dancer control unit. The roll drives can additionally or alternatively also have different speeds, wherein the first roll drive in the direction of movement of the band can have a slightly lower drive speed than the subsequent roll drive, as a result of which an additional tensile force between two roll drives can be generated. Alternatively, the first roll can also be braked instead of driven. In addition to being used for tensile force generation, the dancer control unit can also be used to compensate for speed variations. Alternatively or additionally, a vibration control can be provided.

The device 20 optionally comprises a device 23 for generating at least one magnetic field for applying the at least one magnetic field to the heat treated band material and/or a winding unit 27 with several winding spindles 28 each for winding a defined section of the soft magnetic strip material produced in order to produce a number of toroidal tape cores, wherein the winding unit is formed and connected to the measurement arrangement 25 in such a manner that the winding occurs in reaction to the at least one measured variable determined. Also optionally, the winding unit 27 comprises an additional S-shaped roll drive 29 for feeding the strip material to the respective winding spindle 28.

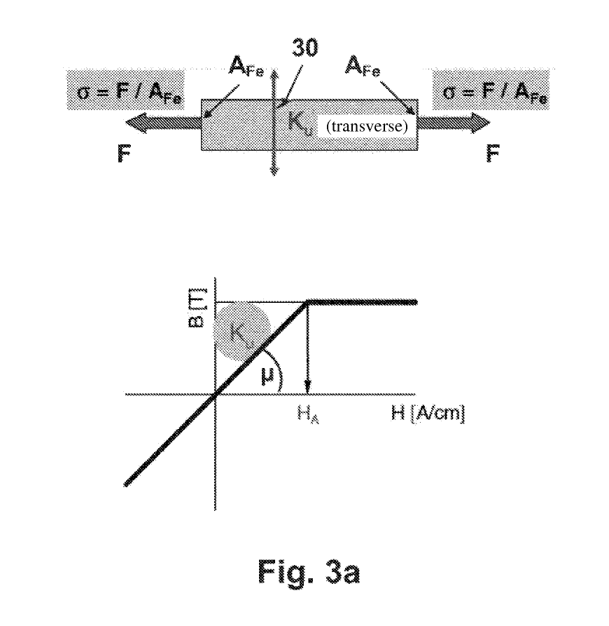

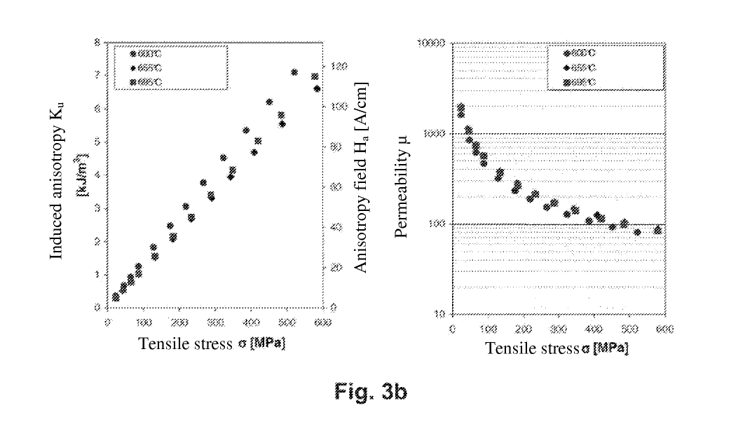

FIGS. 3a and 3b show a relationship between a tensile stress introduced by means of a tensile force F into a band-shaped material 30 and a resulting anisotropy K_{U} or permeability μ. A tensile stress σ existing locally in the band-shaped material 30 is obtained from the tensile force F applied and a local magnetic cross-sectional area A_{Fe} (material cross section) as follows:

$$σ = \frac{F}{{A}_{Fe}} \qquad ( 2 )$$

so that an induced anisotropy K_{U} increases transversely to the longitudinally extended band-shaped material according to the diagram represented in FIG. 3b as a function of the tensile stress σ. A permeability μ is adjusted via the applied tensile stress σ and, as is known, results from the mean slope of the hysteresis loop or from a magnetic flux density B_{S} (saturation magnetization) or from a magnetic field strength H (anisotropy field strength Hₐ) and a magnetic field constant μ₀ in connection with the anisotropy K_{U} as follows:

$$μ = \frac{1}{2} \frac{{B}_{S}^{2}}{{μ}_{0} {K}_{0}} \qquad ( 3 )$$

Thus, for example, if a varying thickness of the band-shaped material is present as a result of the production, then, assuming a constant width, the local cross-sectional area A_{FE} varies accordingly, and with it, at constant tensile force F, the applied tensile stress σ varies. The latter in turn results in a corresponding change of the induced anisotropy K_{U}, which accordingly influences, via the mentioned relationships, the permeability μ, so that the latter also changes over the length of the soft magnetic strip material produced hereby from the band-shaped material.

FIG. 3b moreover shows a curve of the permeability as a function of the tensile stress σ for three heat treatment temperatures.

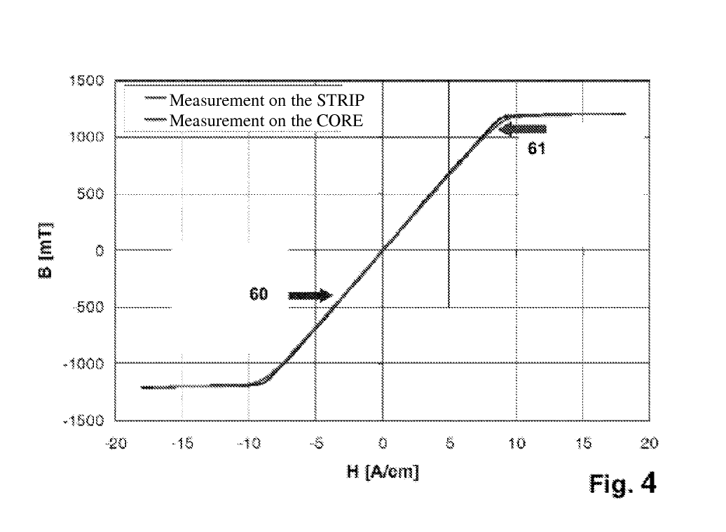

FIG. 4 shows a comparison of a hysteresis 60 measured on an unwound soft magnetic strip material and a hysteresis 61 determined on the wound core. In order to produce, in accordance with the method according to an embodiment of the invention, a wound toroidal tape core which has the most similar possible or even the same permeability as the strip material, from the unwound soft magnetic strip material, the heat treatment temperature and a throughput speed should be adjusted as a function of a selected material or a selected alloy so that a magnetostriction in a nanocrystalline state of the strip material is below 1 ppm.

The product from bending stresses resulting from the winding of the strip material and the value of the magnetostriction represents an additional anisotropy induced in the wound strip material and should therefore be kept as small as possible. Otherwise, the permeability of the magnet core would differ more or less strongly from that of the unwound strip material. Thus, it is the case that the higher the anisotropy induced at the time of the production of the unwound soft magnetic material is, the more sensitive the toroidal tape core is to the ever constant, small additional anisotropies due to the winding stresses.

As is evident from the hysteresis curve represented, a permeability μ is in the 1000 range. This corresponds to a small to moderately strong induced anisotropy. Except for small defects in an area leading to a magnetic saturation, the two hysteresis curves for the unwound soft magnetic strip material 60 and the wound ring band 61 can be considered to be identical.

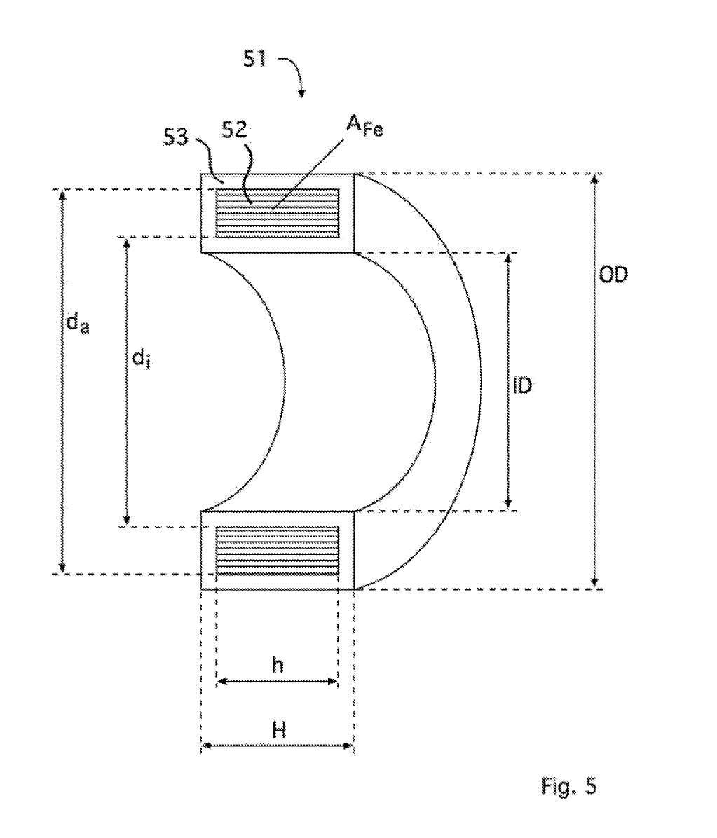

FIG. 5 shows a section through a magnet core 51 which comprises a wound toroidal tape core 52 and a coating 53 consisting of a powder paint. The coating 53 immobilizes the toroidal tape core 52. Such an immobilization allows a reduction in the size of the magnet core. In the present invention, such an immobilization is possible in spite of the mechanical stresses introduced thereby, since the magnet cores have a low magnetostriction.

The toroidal tape core 52 has a height h, an outer diameter dₐ and an inner diameter dᵢ. The powder paint coating 53 is applied to the surfaces of the toroidal tape core. Thus, the magnet core 51 has a height H, an outer diameter OD and an inner diameter ID. Furthermore, the band cross-sectional area A_{Fe} is marked in FIG. 5.

### EXAMPLES

The following examples illustrate the invention in relation to comparison examples. Band-shaped materials were selected for this purpose, whose composition is indicated in Table 1. These band-shaped materials were subjected to a heat treatment and additional process steps for producing a soft magnetic strip material, in order to obtain, for example, a nanocrystalline alloy based on iron or an amorphous alloy based on cobalt. Details regarding the further steps can be obtained in Table 1, “heat treatment” column. The band-shaped materials of Examples E-1, E-2 and E-3 were subjected to the method according to the invention.

TABLE 1
Composition, properties of band-shaped materials and process steps for
converting the band-shaped materials into soft magnetic strip material

| Band- | | | | |
|---|---|---|---|---|
| shaped | Short | Composition | J_{S} | |
| material | name | [atomic %] | [T] | Heat treatment |
| V-1 | VC 6150 F | Co_{72.5}Fe_{1.5}Mn₄Si₅B₁₇ | 1.0 | Activation in the |
| | | | | magnetic field |
| V-2 | VP 220 F | Fe₆₀Co₇Ni₁₀Cu₁Nb₃Si₁₁B₈ | 1.19 | Crystallization in the |
| | | | | magnetic field as |
| | | | | described in |
| | | | | WO2004/088681 A2 |
| E-1 | VP 800 FF | Fe₇₄Cu₁Nb₃Si_{15.5}B_{6.5} | 1.21 | Crystallization under |
| E-2 | VP 615 FF | Fe_{75.5}Cu₁Nb_{1.5}Si_{15.5}B_{6.5} | 1.34 | tensile stress of |
| E-3 | VP 605 FF | Fe_{76.5}Cu₁Nb_{0.5}Si_{15.5}B_{6.5} | 1.41 | approximately 10-50 MPa |
| | | | | depending on the |
| | | | | target permeability |

J_{S} denotes the saturation magnetization of the amorphous band-shaped material before the crystallization, wherein the saturation magnetization of the nanocrystalline material can then be up to 3% higher. The measurement of the saturation magnetization of the amorphous material was selected, because it is clearly simpler to perform than that of the nanocrystalline material while producing comparable values. V-1 and V-2 are comparison examples. The term “crystallization” refers to the conversion of the amorphous band-shaped material into a soft magnetic strip material consisting of a nanocrystalline alloy based on iron.

The band-shaped materials E-1, E-2 and E-3 are used in the examples according to an embodiment of the invention. Among these, E-2 and E-3 are particularly preferable, because their saturation magnetization is greater than 1.3 T. As a result of the increase in the saturation magnetization, the size of the magnet core can be further reduced in comparison to that of a magnet core with Example E-1 and Comparison Examples V-1 and V-2, and the mass of the magnet core can be reduced. This is possible since, due to the higher saturation, the permeability can be increased without the magnet core going prematurely into saturation. In addition to the reduction in mass, a magnet core can also be produced more cost effectively from E-2 and E-3 compared to Example E-1 and Comparison Examples V-1 and V-2 due to the lower Nb content.

Table 2 shows Examples E-1a, E-2a and E-3a and Comparison Examples V-1a and V-2a for magnet cores which were obtained from the strip material produced according to Table 1 and intended for 60-A current transformers. E-2a and E-3a are preferred examples. Table 3 shows Examples E-1b, E-2b and E-3b and Comparison Examples V-1b and V-2b for magnet cores which were obtained from the strip material produced according to Table 1 and intended for 100-A current transformers. E-2b and E-3b are preferred examples.

TABLE 2
60 A current transformers

| | | | | | | Phase error | | DC compatibility | |
|---|---|---|---|---|---|---|---|---|---|
| | | Core size | Core immobilized | m_{Fe} | Nom. | [°] | | [A] | |
| Core type | Alloy | dₐ × dᵢ × h [mm] | OD × ID × H [mm] | [g] | perm. | 25° C. | 85° C. | 25° C. | 85° C. |
| V-1a (W639) | VC 6150 F | 22.3 × 17.3 × 6.5 | 23.7 × 15.8 × 7.8 | 6.40 | 1750 | 4°-5° | 5°-6° | 81 | 71 |
| V-2a (V071) | VP 220 F | 23 × 18.6 × 7.2 | 25.8 × 16.2 × 9.4 | 6.17 | 2500 | 4°-5° | 5°-6° | 72 | 73 |
| V-3a (M375) | VP 800 FF | 22 × 17 × 6 | 23.4 × 15.8 × 7.8 | 5.73 | 2000 | 6° | 6°-7° | 80 | |
| E-1a | VP 800 FF | 22.4 × 19.8 × 6.1 | 23.7 × 18.6 × 7.8 | 3.09 | 2400 | 7° | 7.6° | 83 | 70 |
| E-2a | VP 615 FF | 22.3 × 19.9 × 6.1 | 22.8 × 19.3 × 7.8 | 2.80 | 2650 | | | | |
| E-3a | VP 605 FF | 22.2 × 20 × 6.1 | 23.5 × 18.8 × 7.8 | 2.60 | 2800 | | | | |

TABLE 3
100 A current transformers

| | | | | | | Phase error | | DC compatibility | |
|---|---|---|---|---|---|---|---|---|---|
| | | Core size | Core immobilized | m_{Fe} | Nom. | [°] | | [A] | |
| Core type | Alloy | dₐ × dᵢ × h [mm] | OD × ID × H [mm] | [g] | perm. | 25° C. | 85° C. | 25° C. | 85° C. |
| V-1b (W588) | VC 6150 F | 25 × 20 × 6.5 | 26.5 × 18.8 × 7.8 | 7.28 | 1450 | 4°-5° | 5°-6° | 113 | 98 |
| V-2b (V072) | VP 220 F | 27.4 × 21.8 × 7.2 | 30.2 × 19.4 × 9.4 | 9.29 | 1900 | 3°-4° | 4°-5° | 114 | 127 |
| V-3b (M361) | VP 800 FF | 25 × 20.1 × 6 | 26.5 × 18.8 × 7.8 | 6.12 | 1600 | 6° | 6°-7° | 140 | 120 |
| E-1b | VP 800 FF | 25.2 × 21.8 × 6.1 | 26.5 × 20.6 × 7.8 | 4.50 | 1750 | 6.4° | 6.8° | 128 | 107 |
| E-2b | VP 615 FF | 25.1 × 22.0 × 6.1 | 26.4 × 20.8 × 7.8 | 4.10 | 1900 | | | | |
| E-3b | VP 605 FF | 25.0 × 22.1 × 6.1 | 26.2 × 20.9 × 7.8 | 3.80 | 2050 | | | | |

In Tables 2 and 3, in the “Alloy” column, the short name of the alloy as used in Table 1 is indicated. In Tables 2 and 3 this indication means that the alloy described in Table 1 was used for producing a magnet core, after the alloy had been converted by a heat treatment and additional process steps, as indicated in Table 1, into a nanocrystalline alloy based on iron. The nanocrystalline alloy based on iron was obtained in the form of a soft magnetic strip material, which was wound to the form of magnet cores to obtain toroidal tape cores. The toroidal tape cores were coated with a powder paint.

Due to the low magnetostriction (λ_{S}<1 ppm) of the magnet cores according to an embodiment of the invention, they are insensitive to mechanical stresses. Therefore, it was possible to immobilize the toroidal tape cores by means of a thin coating with a powder paint. Such an immobilization type allows a reduction in the size of the magnet core, but, owing to the mechanical stresses introduced hereby, it is feasible only with magnet cores that have a low magnetostriction. In the case of magnetostriction values greater than 1 ppm, the mentioned mechanical stresses would considerably worsen the linearity of the phase error of the current transformers constructed with the core. For example, the alloy VC 220 F has a magnetostriction of 10 ppm. Therefore, with the use of this alloy, the magnet core had to be placed carefully in a trough, with the least stress possible, which led to a comparatively large sizes of the corresponding core types (see V-2a in Table 2 and V-2b in Table 3).

The “core size” column gives the dimension of the toroidal tape core without coating 53 (see FIG. 5). The “core immobilized” column indicates the dimensions of the toroidal tape core provided with a powder paint coating 53.

The “m_{Fe}” column indicates the mass of the uncoated magnet core. One can see that the mass of the examples according to the invention is clearly lower than that of the comparison examples. The magnet cores according to the invention were produced using the method according to the invention with very low sample variation of less than ±2.5%. As a result, the magnet cores according to the invention could be accurately dimensioned, resulting in a clear reduction in mass of up to 50% in comparison to the prior art. The cores produced according to the prior art have a clearly higher sample variation of up to ±20%. This high tolerance has to be maintained during the dimensioning, resulting in greater sizes and higher core masses.

The “Nom. perm.” column refers to the nominal permeability, i.e., the nominal value or the set value of the permeability of the magnet cores (according to DIN 40200 a nominal value is an appropriate, rounded value of a variable for designating or identifying an apparatus or an installation).

The indications in Tables 2 and 3 pertaining to phase errors and DC compatibility furthermore show that the magnet cores according to embodiments of the invention satisfy the standards for current transformers established in IEC 62053-21 and IEC 62053-23. The phase error and DC compatibility were determined according to IEC 62053-21 and IEC 62053-23.

1. A magnet core with a soft magnetic strip material consisting of a nanocrystalline alloy based on iron, which has a permeability μ between 1000 and 3500 and a magnetostriction of less than 1 ppm, wherein the magnet core can be obtained by a method, comprising
providing a band-shaped material;
heat treating the band-shaped material at a heat treatment temperature;
applying to the heat-treated band-shaped material a tensile force in the longitudinal direction of the band-shaped material, thereby generating a tensile stress in the band-shaped material, and obtaining the soft magnetic strip material,
determining at least one measured magnetic variable of the soft magnetic strip material produced, and
controlling the tensile force for adjusting the tensile stress in reaction to the measured magnetic variable determined.

2. The magnet core according to claim 1, wherein the nanocrystalline alloy based on iron contains at least 50 atomic % of iron, at most 4 atomic % of niobium and at least 15 and at most 20 atomic % of silicon.

3. The magnet core according to claim 2, wherein the nanocrystalline alloy based on iron contains at most 2 atomic % of niobium.

4. The magnet core according to claim 1, wherein the nanocrystalline alloy based on iron is an alloy which
consists of Fe_{100-a-b-c-d-x-y-z}CuₐNb_{b}M_{c}T_{d}SiₓB_{y}Z_{z} and up to 1 atomic % of contaminants, wherein M is one or more of the elements Mo, Ta or Zr, T is one or more of the elements V, Mn, Cr, Co or Ni and Z is one or more of the elements C, P or Ge, and wherein
0 atomic %≦a<1.5 atomic %,
0 atomic %≦b<2 atomic %,
0 atomic %≦c<2 atomic %,
0 atomic %≦d<5 atomic %,
14 atomic %<x<18 atomic %,
5 atomic %<y<11 atomic % and
0 atomic %<z<2 atomic %,
the alloy has a nanocrystalline structure in which at least 50 volume % of the grains have a mean size smaller than 100 nm,
the alloy has a magnetic hysteresis loop with a central linear portion,
the alloy has a remanence ratio, Jᵣ/Jₛ, <0.1, and
the alloy has a ratio of coercitivity field strength, H_{c}, to anisotropy field strength, Hₐ, <10%.

5. The magnet core according to claim 1, wherein the nanocrystalline alloy based on iron has a saturation magnetization of more than 1.3 T.

6. The magnet core according to claim 1, wherein the determination of the at least one measured magnetic variable occurs in real time.

7. The magnet core according to claim 1, wherein the at least one measured magnetic variable is selected from a group consisting of magnetic saturation flux, magnetic band cross-sectional area, anisotropy field strength, permeability, coercitivity field strength, and remanence ratio of the soft magnetic strip material produced.

8. The magnet core according to claim 1, wherein the method further comprises winding at least one defined section of the soft magnetic strip material produced for producing the magnet core subsequent to determining the at least one measured magnetic variable.

9. The magnet core according to claim 8, wherein the winding is regulated in reaction to the at least one measured magnetic variable.

10. The magnet core according to claim 8, wherein the winding includes winding a defined number of band layers of the soft magnetic strip material produced in order to produce the magnet core, and defining the number of band layers occurs in reaction to the at least one measured magnetic variable.

11. The magnet core according to claim 1, wherein, at a maximum direct current load of 60 A, said magnet core has a core mass of less than 4.7 g, or wherein, at a maximum direct current load of 100 A, it has a core mass of less than 5.3 g.

12. A method for producing a magnet core with a soft magnetic strip material from a nanocrystalline alloy based on iron, which has a permeability μ between 1000 and 3500 and a magnetostriction of less than 1 ppm, comprising:
providing a band-shaped material;
heat treating the band-shaped material at a heat treatment temperature;
applying to the heat-treated band-shaped material a tensile force in the longitudinal direction of the band-shaped material, thereby generating a tensile stress in the band-shaped material, and obtaining the soft magnetic strip material,
determining at least one measured magnetic variable of the soft magnetic strip material produced, and
controlling the tensile force for adjusting the tensile stress in reaction to the determined measured magnetic variable.

13. The method according to claim 12, wherein the at least one measured magnetic variable is selected from the group consisting of magnetic saturation flux, magnetic band cross-sectional area, anisotropy field strength, permeability, coercitivity field strength, and remanence ratio of the soft magnetic strip material produced.

14. The method according to claim 12, further comprising winding at least one defined section of the soft magnetic strip material produced subsequent to the step of determining the at least one measured magnetic variable, wherein the winding comprises winding a defined number of band layers of the soft magnetic strip material produced for producing the magnet core, and defining the number of band layers occurs in reaction to the at least one measured magnetic variable.

15. A current transformer, comprising a magnet core according to claim 1.
